(19) United States
(12) Patent Application Publication
(10) Pub. No.: US 2026/0302919 A1
(43) Pub. Date: Oct. 1, 2026

(54) POWER CONVERTER SYSTEM AND METHOD FOR OPERATING POWER CONVERTER SYSTEM FOR REDUCING LOSSES IN DC LINK OF THE POWER CONVERTER SYSTEM

(71) Applicant: Danfoss Power Electronics A/S, Grästen (DK)

(72) Inventors: Radu Dan LAZAR, Nordborg (DK); Nicklas CHRISTENSEN, Nordborg (DK)

(21) Appl. No.: 19/630,682

(22) Filed: Mar. 27, 2026

(30) Foreign Application Priority Data
Apr. 1, 2025 (DE) 102025112671.2

(51) Int. Cl. H02M 1/00; H02M 1/14

(52) U.S. Cl. CPC H02M 1/0048; H02M 1/0003; H02M 1/143

(57) ABSTRACT

The disclosure relates to a power converter system (100) including one or more input converters (10) with an input converter topology, one or more output converters (12) with an output converter topology, and a DC link (14) including one or more energy storages (15), wherein the DC link is connected between the input converter(s) (10) and the output converter(s) (12). The power converter system (100) including a controller (20) configured to adjust an operating point, defined by an output frequency and an output angle, to minimize operation at one or more predefined undesirable operating point ranges (122) for reducing losses in the DC link (14). The one or more predefined undesirable operating point ranges (122) are determined based on: the input converter topology, the output converter topology, an angle difference between the output and input angles, and a frequency difference between the output and the input frequencies.

### CROSS-REFERENCE TO RELATED APPLICATION

This application claims foreign priority benefits under 35 U.S.C. § 119 to German Patent Application No. 102025112671.2 filed on Apr. 1, 2025, the content of which is hereby incorporated by reference in its entirety.

### TECHNICAL FIELD

The present invention relates in general to power converter systems. In particular, however not exclusively, the present invention concerns reducing or minimizing losses in a DC link of a power converter system, such as of a frequency converter.

### BACKGROUND

Typical frequency converters include a rectifying circuit, which may be called, for example, a line bridge, a network bridge, or a rectifier bridge, for converting electrical quantities from alternating current (AC) to direct current (DC), and an inverter circuit, which may be called, for example, a motor bridge, an inverter bridge, or a load bridge, from DC to AC. As known, some of the rectifying circuits and the inverter circuit are bidirectional in that they are able to transfer power in both of the directions. The frequency converters also include a DC link, or DC bus or DC intermediate circuit, typically comprising one or more DC link capacitors, where the DC link is connected between the rectifying circuit and the inverter circuit.

Even though most of the electric power is being converted, a portion of the energy is lost in the form of electric power losses. One of the components in which the losses occur is in the DC link and, specifically, in the capacitor or capacitors thereof. The losses in the capacitors are undesirable and decrease the lifetime of the capacitors. Also, there occurs increased stress in the DC link when low frequency content of the rectifier is aligned with the low frequency content of inverter. There is thus a need to develop solutions for reducing or minimizing losses and stress incurring in the DC link, such as, for improving efficiency of frequency converters as well as lifetime of the capacitor(s) of DC link.

### SUMMARY

An objective of the present invention is to provide a power converter system and a method for operating a power converter system for reducing losses in a DC link of the power converter system. Another objective of the present invention is that the power converter system and the method reduces or minimizes losses in the DC link of the power converter system.

The objectives of the invention are reached by a power converter system and a method for operating a power converter system for reducing losses in a DC link of the power converter system as defined by the respective independent claims.

According to a first aspect, a power converter system, such as comprising a frequency converter, is provided. The power converter system comprises one or more input converters with an input converter topology and one or more output converters with an output converter topology. The power converter system further comprises a DC link comprising one or more energy storages, wherein the DC link is connected between the one or more input converters and the one or more output converters. The power converter system further comprises a controller configured to control the one or more output converters to produce one or more output waveforms with an output frequency and an output angle, and to determine an input frequency and an input angle of the one or more input converters.

The controller is configured to adjust an operating point, defined by the output frequency and the output angle, to minimize operation at one or more predefined undesirable operating point ranges for reducing losses in the DC link, wherein the one or more predefined undesirable operating point ranges are determined based on: (i) the input converter topology, (ii) the output converter topology, (iii) an angle difference between the output angle and the input angle, and (iv) a frequency difference between the output frequency and the input frequency.

The determination based on the (i)-(iv) as listed above may refer to the input converter topology and the output converter topology of the converters in question being determined, and subsequently losses occurring in the DC link in different operating points as a function of the angle difference and the frequency difference for said topologies being determined, and finally the one or more predefined undesirable operating point ranges may be determined.

Said determination of losses occurring in the DC link may include, for example, modelling, performing calculations, utilizing (a) table(s) with pre-stored data of the losses occurring in the DC link in different operating points, or utilizing a pre-recorded operation data of converters with said topologies.

Furthermore, optionally, (v) a relative loading of the power converter system may be taken into account in said determination in addition to the (i)-(iv). Thus, the one or more pre-defined undesirable operating point ranges may be determined for the topologies in question based on (iii) the angle difference, (iv) the frequency difference, and (v) the relative loading.

Thus, the one or more predefined undesirable operating point ranges may be defined by a combination of one or more values of the output frequency and one or more values of the output angle with respect to the input frequency and the input angle.

The power converter system may be configured to have a nominal operating range defined by a combination of one or more values of the output frequency and one or more values of the output angle.

The nominal operating range may comprise, in a non-overlapping manner, one or more acceptable operating point ranges and the one or more predefined undesirable operating point ranges.

Furthermore, operation in the one or more predefined undesirable operating point ranges causes higher losses in the DC link than operation in the acceptable operating point ranges.

The nominal operating range may further comprise one or more preferred operating point ranges. The one or more preferred operating point ranges may be predefined so that operation in them causes lower losses in the DC link than operation in the acceptable operating point ranges. The one or more preferred operating point ranges may be included in the acceptable operating point ranges in which case operation in them causes lower losses than operation in the adjacent acceptable operating point ranges. Alternatively, the one or more preferred operating point ranges may be non-overlapping relative to the acceptable operating point ranges and, of course, the one or more predefined undesirable operating point ranges.

The nominal operating range may be further defined by a relative loading of the power converter system.

The nominal operating range may comprise the one or more predefined undesirable operating point ranges only for values of the relative loading over 0.7 or 70%, or more preferably 0.6 or 60%, or optionally over 0.5 or 50%.

The power converter system may be configured with or to receive information about the input converter topology and the output converter topology, and to define the one or more predefined undesirable operating point ranges based on the received input converter topology and the received output converter topology. The information may be set by the person installing and setting up the power converter system, or the information may have been preset when manufacturing the power converter system.

The power converter system may be configured with or to receive information about a modulation technique, and to define the one or more predefined undesirable operating point ranges further based on the modulation technique.

The controller may be configured to synchronize the output frequency and the output angle with the input frequency and the input angle, respectively. The output angle may subsequently be adjusted to have a predefined angle shift relative to the input angle for avoiding operating at one or more undesirable phase angles related to the one or more predefined undesirable operating point ranges.

The controller may be configured to adjust the output angle to change pass one or more undesirable phase angles related to the one or more predefined undesirable operating point ranges faster than in case of operating points around the one or more predefined undesirable operating point ranges. Optionally, the adjusting of the output angle may be based on a control reference providing a higher rate of angle change at the one or more undesirable phase angles than at phase angles around the one or more undesirable phase angles. The control reference may be a chirp like signal arranged to produce the higher rate of angle change at the one or more undesirable phase angles. The purpose of the control reference may be to compensate the motor frequency so that transition through undesirable phase angles is faster.

The controller may be configured to adjust the output frequency to be different than the input frequency by a predefined frequency shift for ensuring faster transition pass one or more undesirable phase angles related to the one or more predefined undesirable operating point ranges.

The power converter system may comprise a plurality of output converters, that is more than one, connected to the DC link, preferably in parallel relative to each other. The controller may be configured to adjust output angles of the plurality of output converters relative each other and relative to the input angle of the power converter system to reduce losses in the DC link.

According to a second aspect, a method for operating a power converter system for reducing losses in a DC link of the power converter system is provided. The power converter system comprises one or more input converters with an input converter topology and one or more output converters with an output converter topology. The DC link comprises one or more energy storages, such as one or more capacitors and/or one or more batteries, and is connected between the one or more input converters and the one or more output converters.

The method comprises determining an input frequency and an input angle of the power converter system.

The method also comprises adjusting an output frequency and an output angle of the one or more output converters to minimize operation at one or more pre-defined undesirable operating point ranges for reducing losses in the DC link, wherein the one or more predefined undesirable operating point ranges are determined based on: (i) the input converter topology, (ii) the output converter topology, (iii) an angle difference between the output angle and the input angle, and (iv) a frequency difference between the output frequency and the input frequency.

The determination based on the (i)-(iv) as listed above may refer to determining the input converter topology and the output converter topology of the converters in question, and subsequently determining losses occurring in the DC link in different operating points as a function of the angle difference and the frequency difference for said topologies, and finally determining the one or more predefined undesirable operating point ranges.

Said determining of losses occurring in the DC link may include, for example, modelling, performing calculations, utilizing (a) table(s) with pre-stored data of the losses occurring in the DC link in different operating points, or utilizing a pre-recorded operation data of converters with said topologies.

Furthermore, optionally, (v) a relative loading of the power converter system may be taken into account in said determination in addition to the (i)-(iv). Thus, the one or more pre-defined undesirable operating point ranges may be determined for the topologies in question based on (iii) the angle difference, (iv) the frequency difference, and (v) the relative loading.

For example, two of the (iii)-(v) may be used as variables for one of the (iii)-(v) that is fixed. In some examples, the frequency difference may be fixed to a certain value, and then the angle difference and the relative loading are used to define the one or more pre-defined undesirable operating point ranges for said fixed frequency difference. Other choices for the fixed one of the (iii)-(v) are, of course, possible.

The method may comprise synchronizing the output frequency and the output angle with the input frequency and the input angle, respectively, and subsequently adjusting the output angle to have a predefined angle shift relative to the input angle for avoiding operating at one or more undesirable phase angles related to the one or more predefined undesirable operating point ranges.

In addition or alternatively to above synchronizing, the method may comprise adjusting the output angle to change pass one or more undesirable phase angles related to the one or more predefined undesirable operating point ranges faster than in case of operating points around the one or more predefined undesirable operating point ranges.

The adjusting of the output angle may be based on a control reference, such as a non-linear control reference, providing a higher rate of angle change at the one or more undesirable phase angles than at phase angles around the one or more undesirable phase angles.

The control reference may be a chirp like signal arranged to produce the higher rate of angle change at the one or more undesirable phase angles.

The method may comprise adjusting the output frequency to be different than the input frequency by a predefined frequency shift for ensuring faster transition pass one or more undesirable phase angles related to the one or more predefined undesirable operating point ranges.

Furthermore, wherein the power converter system comprises a plurality of output converters connected to the DC link, the method may comprise adjusting output angles of the plurality of output converters relative each other, such as to avoid similar angles, and, optionally, relative to the input angle of the power converter system, such as to avoid low input angles, to reduce losses in the DC link.

The present invention provides a power converter system and a method for operating a power converter system for reducing losses in a DC link of the a power converter system. The present invention provides advantages over known solutions in that avoiding or minimizing operation time within the one or more predefined undesirable operating point ranges reduces losses incurring and stress caused in the DC link as well as increases lifetime of the DC link components.

Various other advantages will become clear to a skilled person based on the following detailed description.

The expression “a number of” may herein refer to any positive integer starting from one (1).

The expression “a plurality of” may refer to any positive integer starting from two (2), respectively.

The terms “first”, “second”, and “third” are herein used to distinguish one element from other element, and not to specially prioritize or order them, if not otherwise explicitly stated.

The exemplary embodiments of the present invention presented herein are not to be interpreted to pose limitations to the applicability of the appended claims. The verb “to comprise” is used herein as an open limitation that does not exclude the existence of also unrecited features. The features recited in the appended patent claims are mutually freely combinable unless otherwise explicitly stated.

The novel features which are considered as characteristic of the present invention are set forth in particular in the appended claims. The present invention itself, however, both as to its construction and its method of operation, together with additional objectives and advantages thereof, will be best understood from the following description of specific embodiments when read in connection with the accompanying drawings.

### BRIEF DESCRIPTION OF THE DRAWINGS

Some embodiments of the invention are illustrated by way of example, and not by way of limitation, in the figures of the accompanying drawings.

FIG. 1 illustrates schematically a power converter system.

FIG. 2 shows an example of a nominal operating range of a power converter system.

FIG. 3 shows another example of a nominal operating range of a power converter system.

FIG. 4 shows a flow diagram of a method for operating a power converter system for reducing losses in a DC link of the power converter system.

FIG. 5 illustrates losses in a DC link of a power converter system according a first example.

FIG. 6 illustrates losses in a DC link of a power converter system according a second example.

FIG. 7 illustrates losses in a DC link of a power converter system according a third example.

FIGS. 8-10 illustrate an example of a frequency difference, an angle difference, and a motor speed difference as a function of time.

FIG. 11A-11C illustrate an example of the effect of angle difference on DC link current of a power converter system with one input converter and one output converter.

FIG. 12A-12C illustrate an example of the effect of phase shift in angles of output converters on DC link current of a power converter system with one input converter and two output converters.

### DETAILED DESCRIPTION

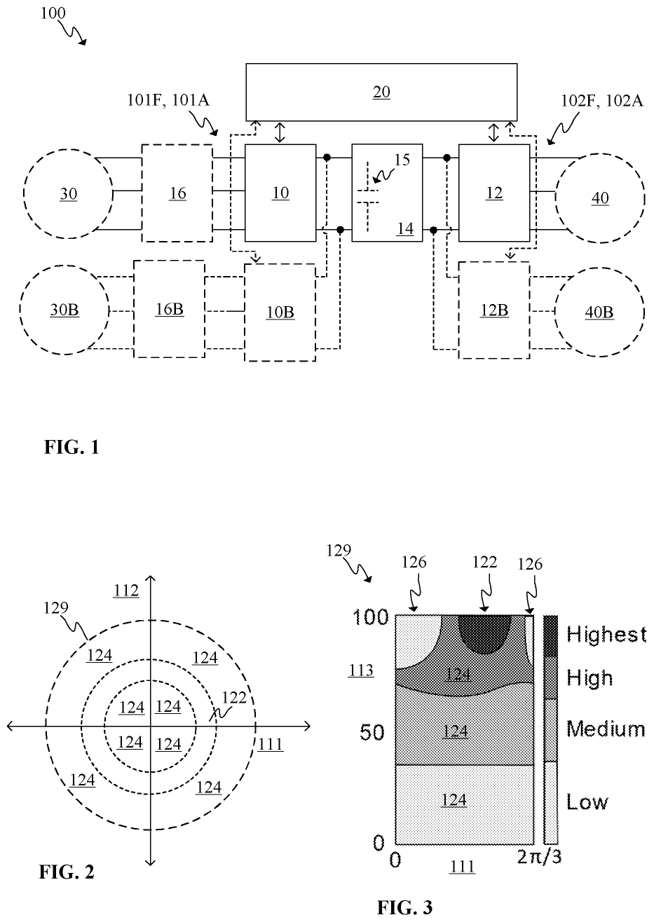

FIG. 1 illustrates schematically a power converter system 100. The power converter system 100 comprises one or more input converters 10 with an input converter topology and one or more output converters 12 with an output converter topology. The power converter system 100 also comprises a DC link 14 comprising one or more energy storages 15, for example but not limited to, one or more capacitors and/or batteries, wherein the DC link 14 is connected between the one or more input converters 10 and the one or more output converters 12. In addition, the power converter system 100 comprises a controller 20 configured to control the one or more output converters 12 to produce one or more output waveforms with an output frequency 102F and an output angle 102A, and to determine an input frequency 101F and an input angle 101A of the one or more input converters 10.

The controller 100 is configured to adjust an operating point, defined by the output frequency 102F and the output angle 102A, to minimize operation at one or more predefined undesirable operating point ranges for reducing losses in the DC link 14. The one or more predefined undesirable operating point ranges are determined based on the input converter topology, the output converter topology, an angle difference between the output angle 102A and the input angle 101A, and a frequency difference between the output frequency 102F and the input frequency 101F.

The determination based on the input converter topology, the output converter topology, the angle difference, and the frequency difference may refer to the input converter topology and the output converter topology of the converters in question being first determined, and subsequently losses occurring in the DC link in different operating points as a function of the angle difference and the frequency difference for said topologies being determined, and finally the one or more predefined undesirable operating point ranges may be determined. The one or more predefined undesirable operating point ranges may then be stored into a memory (device) of the power converter system 100 to be used during operation of the system 100.

The controller 20 may in addition be configured to control other functions of the power converter system 100 as well, such as related to safety or electric power quality, etc.

The frequency converter 100 may optionally comprise an input filter 16, such as comprising one or more inductors and/or one or more capacitors, such as per input phase.

FIG. 1 also illustrates a number of electric sources 30, for example, an electrical grid or a connection thereto, and a number of loads 40, such as an electric motor or a connection thereto.

FIG. 2 shows an example of a nominal operating range 129 of a frequency converter 100. The horizontal axis represents the angle difference 111. The vertical axis represents the frequency difference 112.

The nominal operating range 129 includes at least the one or more predefined undesirable operating point ranges 122 and other operation point ranges. The other operation points ranges may be or may at least include one or more acceptable operating point ranges 124, preferably, in a non-overlapping manner with respect to the one or more predefined undesirable operating point ranges 122. Thus, the one or more predefined undesirable operating point ranges 122, such as within the nominal operating range 129, may be defined by a combination of or as a function of one or more values of the output frequency 102F and one or more values of the output angle 102A with respect to the input frequency 101F and the input angle 101A. For example, for a value of the frequency difference 112, a particular angle difference may be either within the one or more predefined undesirable operating point ranges 122 or outside thereof. Operation in the one or more predefined undesirable operating point ranges 122 causes higher losses in the DC link 14 than operation in the acceptable operating point ranges 124. Therefore, avoiding or minimizing operation within the one or more predefined undesirable operating point ranges 122 reduces losses in the DC link 14.

FIG. 3 shows another example of a nominal operating range 129 of a frequency converter 100. The horizontal axis represents the angle difference 111. The vertical axis represents a relative loading 113 of the frequency converter 100. Thus, in FIG. 3, the nominal operating range 129 is defined for a single value of the frequency difference 112 and/or the output frequency 102F. The nominal operating range 129 comprises a predefined undesirable operating point range 122 and other operation point range(s), namely acceptable operating point range(s) 124. The relative loading 113 ranges from zero to 100% (or to one). The angle difference 111 ranges from 0 to 120 degrees (0 to 2π/3 radians). Terms “Highest”, “High”, “Medium”, and “Low” in FIG. 3 refer to the amount of relative losses in the DC link 14.

In the example of FIG. 3, there is one predefined undesirable operating point range 122 centred around a value of the angle difference 111 of approximately 80 degrees. The range 122 is narrower (on the horizontal axis) at lower values of relative loading 113 compared to values at higher values of the relative loading 113. The range 122 is widest (on the horizontal axis) at the relative loading of 100%.

Furthermore, the nominal operating range 129 may further comprises one or more preferred operating point ranges 126. The one or more preferred operating point ranges 126 may be predefined so that operation in them causes lower losses in the DC link 14 than operation in the acceptable operating point ranges 124. The one or more preferred operating point ranges 126 may be included in the acceptable operating point ranges 124 in which case operation in them causes lower losses than operation in the adjacent acceptable operating point ranges 124. Alternatively, the one or more preferred operating point ranges 126 may be non-overlapping relative to the acceptable operating point ranges 124 and, of course, the one or more predefined undesirable operating point ranges 122.

In the example of FIG. 3, there is one preferred operating point range 126 centred around a value of the angle difference 111 of approximately 0-30 degrees and another one at 120 degrees. The preferred operating point ranges 126 are narrower at lower values of relative loading 113 compared to values at higher values of the relative loading 113. The preferred operating point range 126 is widest at the relative loading of 100%.

FIG. 3 shows the nominal operating range 129 comprising the predefined undesirable operating point range 122 only for values of the relative loading approximately over 0.6 or 60%. Thus, the nominal operating range 129 may consist of only the acceptable operating point range 124 substantially independent of the value of the angle difference 111 and/or the output angle 102A certain values of the relative loading. The losses occurring in the DC link 14 may in many cases be substantially the same for all values of the angle difference 111 and/or the output angle 102A when the relative loading is low enough. However, for higher values of the relative loading 113, the losses in the DC link 14 may indeed vary as a function of the angle difference 111 and/or the output angle 102A as shown.

In general, various input and output converter topology combinations were noticed to have varying power losses in the DC link 14 especially at higher relative loads, for example, as will be shown in FIGS. 5-7. The power losses in the DC link 14 are varying depending on the frequency 112 and angle differences 111, and the topologies of the converters in question. The modulation technique can also have some effect on the losses.

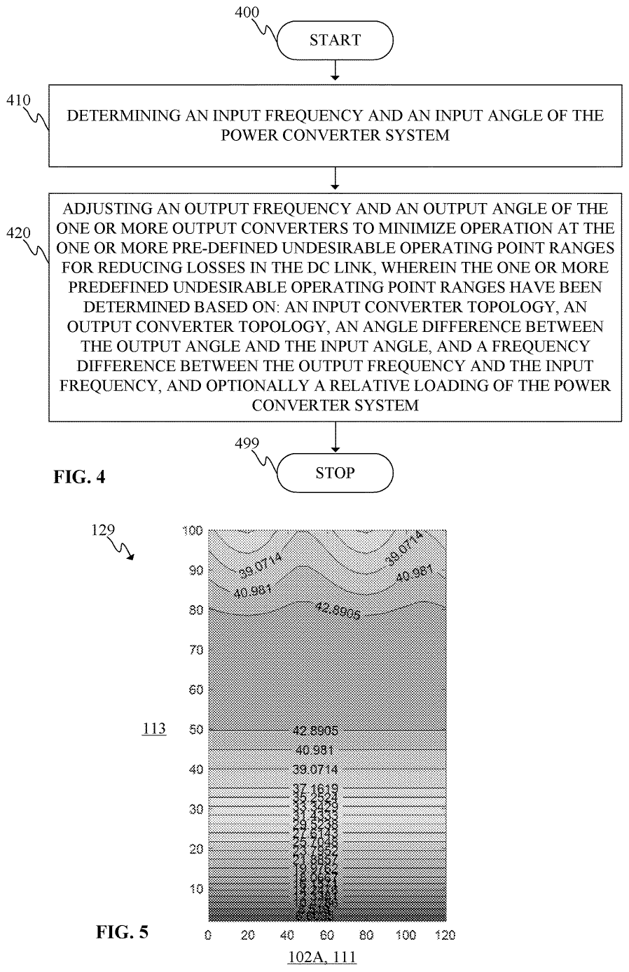

FIG. 4 shows a flow diagram of a method for operating a power converter system 100 for reducing losses in a DC link 14 of the power converter system 100. The method steps may be performed by utilizing the controller 20. Thus, the controller 20 may be configured to perform the method steps and/or to cause some other device(s) of the system 100 to perform them.

Item or method stop 400 refers to an optional start-up phase of the method.

Item or method stop 410 refers to determining an input frequency 101F and an input angle 101A of the frequency converter 100. The input frequency 101F and the input angle 101A may be determined by using voltage and/or current measuring means, such as voltage and/or current sensor(s). On the other hand, the input frequency 101F and the input angle 101A may be provided to the power converter system 100 by another device in communication connection with the power converter system 100. In some embodiments, the input frequency 101A may be pre-defined/assumed to be the nominal frequency of the electric source 30, such as of the electrical grid. Thus, for the frequency difference 112, only the output frequency 102F needs to be determined.

In various embodiments, the input frequency 101F may refer to the frequency in the electrical grid, such as being (close to) 50 Hz or 60 Hz, for instance. The determined input angle 101A may be chosen as the reference for determining the output angle 102A and/or the angle difference 111. For example, an input phase voltage may be used as providing a reference value against which the output angle 102A and/or the angle difference 111 may be determined.

Item or method stop 420 refers to adjusting the output frequency 102F and the output angle 102A of the one or more output converters 10 to minimize operation at one or more pre-defined undesirable operating point ranges 122 for reducing losses in the DC link 14, wherein the one or more predefined undesirable operating point ranges 122 are determined based on: the input converter topology, the output converter topology, an angle difference 111 between the output angle 102A and the input angle 101A, and a frequency difference 112 between the output frequency 102F and the input frequency 101F.

Optionally, the relative loading 113 of the power converter system 100 may be taken into account in said determination of the one or more predefined undesirable operating point ranges 122. The relative loading 113 may be taken into account in addition to the input converter topology, the output converter topology, the angle difference 111, and the frequency difference 112. Thus, the one or more pre-defined undesirable operating point ranges 122 may be determined for the topologies in question based on the angle difference, the frequency difference, and the relative loading.

The method may comprises determining the input converter topology and the output converter topology of the converters in question, and subsequently determining losses occurring in the DC link in different operating points as a function of the angle difference and the frequency difference for said topologies, optionally at different relative loading 113, and finally determining the one or more predefined undesirable operating point ranges 122. The determined predefined undesirable operating point ranges 122 may be stored into a memory device of the power converter system 100 for use during the operation thereof.

As shown in FIG. 3, for instance, there may be one or more operating point ranges, depending on the combination of the topologies as will be further explained hereinbelow in more detail, in which the losses in the DC link 14, such as in the capacitor(s) thereof, are higher than in other, surrounding operating point ranges. These may be predefined and stored into the controller 20 of the power converter system 100. Thus, the controller 20 may be configured to at least minimize operating in such pre-defined undesirable operating point ranges 122. For example, the method may comprise synchronizing the output frequency 102F and the output angle 102A with the input frequency 101F and the input angle 101A, respectively, in order to operate at the preferred operating point range 126 on the left in FIG. 3, in case the relative loading 113 is at or increases to a high value (in this case higher than about 75%).

The method may be stopped at item or method step 499.

FIG. 5 illustrates losses in a DC link 14 of a power converter system 100 according a first example. The input converter 10 is arranged to have a topology called a six-pulse diode rectifier. Furthermore, the output converter 12 is arranged to have a topology called a half-bridge. The horizontal axis represents the output angle 102A or the angle difference 111. The vertical axis represents the relative loading 103 in watts. As can be seen, the power contour lines are substantially horizontal for values of the relative loading 103 below 50% or 0.5. However, there are two operating point ranges around values of the output angle 102A or the angle difference 111 of about 20 degrees and 80 degrees incurring less losses in the DC link 14 than when operating in other operating point ranges adjacent to them. Operating in these operating point ranges, namely acceptable operating point ranges 124 or preferred operating point ranges 126, cause less losses in the DC link 14 than operating around, for example, 45 degrees or 100 degrees which may be predefined to be predefined undesirable operating point ranges 122.

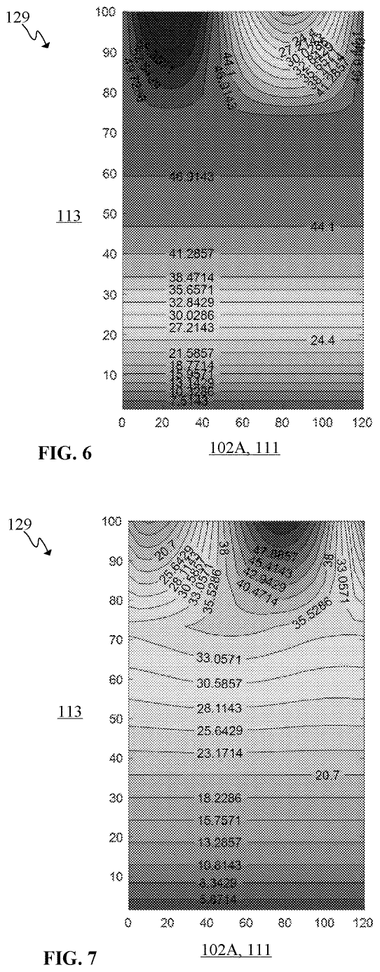

FIG. 6 illustrates losses in a DC link 14 of a power converter system 100 according a second example. The input converter 10 is arranged to have a topology called a six-pulse diode rectifier. Furthermore, the output converter 12 is arranged to have a topology called a T-type inverter. The horizontal axis represents the output angle 102A or the angle difference 111. The vertical axis represents the relative loading 103 in watts. In this case, the power contour lines are substantially horizontal for values of the relative loading 103 below 60% or 0.6. However, there are two special operating point ranges around values of the output angle 102A or the angle difference 111 of about 22 degrees and 82 degrees. Operating close to or at the 22 degrees incurs more losses in the DC link 14 than when operating in other operating point ranges adjacent to them. This may be predefined to be a predefined undesirable operating point range 122. Operating close to or at the 82 degrees, on the other hand, incurs less losses in the DC link 14 than operating in other operating point ranges adjacent to them. This may be predefined to be a preferred operating point range 126. Other operating points of preferred operating point range 126 may be included in the acceptable operating point range(s) 124.

FIG. 7 illustrates losses in a DC link 14 of a power converter system 100 according a third example. The input converter 10 is arranged to have a topology called a T-type rectifier. Furthermore, the output converter 12 is arranged to have a topology called a T-type inverter. The horizontal axis represents the output angle 102A or the angle difference 111. The vertical axis represents the relative loading 103 in watts. In this case too, the power contour lines are substantially horizontal for values of the relative loading 103 below 50% or 0.5. However, there are two special operating point ranges around values of the output angle 102A or the angle difference 111 of about 10 degrees and 80 degrees. Operating close to or at the 10 degrees incurs less losses in the DC link 14 than when operating in other operating point ranges adjacent to them. This may be predefined to be a preferred operating point range 126. Operating close to or at the 80 degrees, on the other hand, incurs more losses in the DC link 14 than operating in other operating point ranges adjacent to them. This may be predefined to be a predefined undesirable operating point range 122. Other operating points may be included in the acceptable operating point range(s) 124. Optionally, the operating range close to or at the 10 degrees may be included in the acceptable operating point range(s) 124. Furthermore, the operating range close to or at the 120 degrees may be considered to be another preferred operating point range 126 or included in the acceptable operating point range(s) 124. This is similar to the situation shown in FIG. 3.

Thus, going back to the method as shown and discussed in connection with FIG. 4, and especially in view of FIGS. 5 and 7, in may be advantageous that the method may comprise synchronizing the output frequency 102F and the output angle 102A with the input frequency 101F and the input angle 101A, respectively, and subsequently adjusting the output angle 102A to have a predefined angle shift relative to the input angle 101A for avoiding operating at one or more undesirable phase angles related to the one or more predefined undesirable operating point ranges 122. Thus, as illustrated in FIG. 3, the angle difference 111 can first be adjusted to zero and then slightly, if at all, adjusted to have the predefined angle shift, such as in the range of 10 to 20 degrees. For example, in case the motor set point is close to the grid frequency, the motor frequency is synchronized with the grid frequency and angle. Then, a small angle offset is applied to pursue or even ensure continuous operation at some other point than the predefined undesirable operating point ranges 122. On the other hand, with topologies used in the situation shown in FIG. 6, this may not be as beneficial.

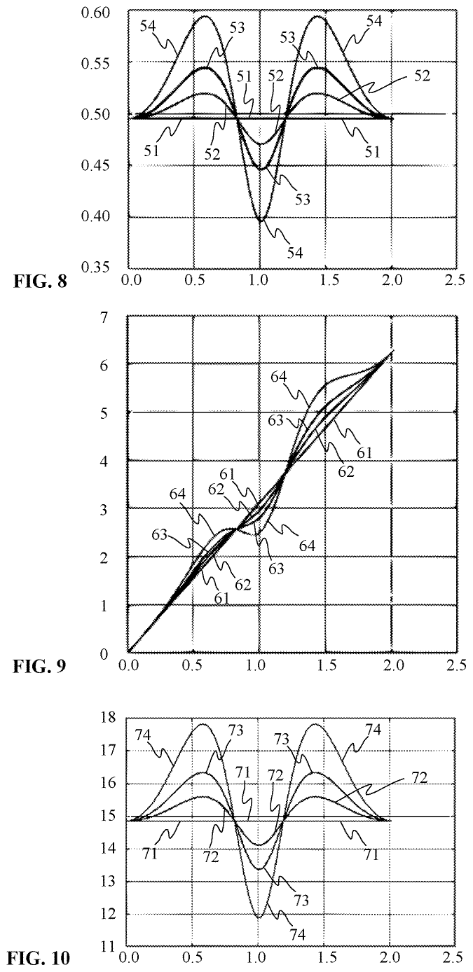

Alternatively, or in addition, the method may, for example, comprise adjusting the output angle 102A to change pass one or more undesirable phase angles related to the one or more predefined undesirable operating point ranges 122 faster than in case of operating points around the one or more predefined undesirable operating point ranges 122. This may refer to the controller 20 changing the operating point faster pass the one or more undesirable phase angles than for other operation points. This may be performed, for example, by the adjusting of the output angle 102A based on a control reference, such as for or being used in the controller 20 to control output values, wherein the control reference provides a higher rate of angle change at the one or more undesirable phase angles than at phase angles around the one or more undesirable phase angles. Thus, the time of operation at or near the one or more undesirable phase angles is minimized. The control reference may be non-linear in order to provide the higher rate of angle change at the one or more undesirable phase angles 122 than at phase angles around the one or more undesirable phase angles 122. As one example, the control reference is a chirp like signal arranged to produce the higher rate of angle change at the one or more undesirable phase angles. An example of the effect of the control reference such as mentioned herein is illustrated in FIGS. 8-10 which will be described later below.

As a further example, the method may comprise adjusting the output frequency 102F to be different than the input frequency 101F by a predefined frequency shift for ensuring faster transition pass one or more undesirable phase angles related to the one or more predefined undesirable operating point ranges 122. For example, in case the motor set point frequency is at 49.5 Hz, which is close to for example a grid frequency of 50 Hz, the motor speed is reduced to, for example, 49 Hz, such that the frequency difference 112 is increased. This will ensure a twice as fast transition through the undesirable operating point ranges 122 which leads to a lower stress of the DC link capacitors 15.

In view of the examples disclosed above, it becomes clear that the controller 20 may be configured to utilize one or more predefined undesirable operating point ranges 122 being determined by a combination of the topologies, and the angle difference 111, the frequency difference 112, and optionally the relative loading 113. The specific frequencies at which the speed and angle adjustment is performed at, depends on the combination of the topologies.

For example, the worst case for a diode rectifier and a three-level converter is the combination of 50 Hz of grid frequency as the electric source 30 and 100 Hz for a motor as the load 40. For a three-level grid converter and a three-level inverter the worst case is at close frequencies, meaning for example 50 Hz grid and 50.1 Hz motor.

FIGS. 8-10 illustrate an example of a frequency difference 112, an angle difference 111, and a motor speed difference as a function of time, the motor being the load 40 in this case. In these figures, the effect of the control reference, namely including the chirp like signal arranged to produce the higher rate of angle change at the one or more undesirable phase angles, is illustrated.

FIG. 8 illustrates a first frequency difference 51 with a linear reference signal, a second frequency difference 52 with a first control reference having a first gain value, a third frequency difference 53 with a second control reference having a second gain value, and a fourth frequency difference 54 with a third control reference having a third gain value. The third gain value is the highest, the second gain value is the second highest, and the first gain value is the smallest. In cases of 52-54, the control reference may be non-linear or otherwise provide, due to its shape or by other means, the higher rate of angle change at the one or more undesirable phase angles 122 than at phase angles around the one or more undesirable phase angles 122.

FIG. 9 illustrates a first angle difference 61 with the linear reference signal, a second angle difference 62 with the first linear control reference, a third angle difference 63 with the second reference, and a fourth angle difference 64 with the third control reference. In cases of 62-64, the control reference may be non-linear or otherwise provide, due to its shape or by other means, the higher rate of angle change at the one or more undesirable phase angles 122 than at phase angles around the one or more undesirable phase angles 122.

FIG. 10 illustrates a first motor speed difference 71 with the linear reference signal, a second motor speed difference 72 with the first control reference, a third motor speed difference 73 with the second control reference, and a fourth motor speed difference 74 with the third control reference. In cases of 72-74, the control reference may be non-linear or otherwise provide, due to its shape or by other means, the higher rate of angle change at the one or more undesirable phase angles 122 than at phase angles around the one or more undesirable phase angles 122.

FIGS. 8-10 show an example with a predefined undesirable operating point range 122 being at or around an angle phase difference between motor and grid phases of 180 degrees (or π). The compensation with the control reference, namely including the chirp like signal, is applied with using different gains, as described hereinabove, for illustrating the difference in angle slopes around the undesirable operating point range 122.

The impact of the control reference, such as including the chirp like signal, on the motor speed is illustrated in FIG. 10 for a typical two pole-pair 50 Hz motor, running at a nominal speed of 1500 rpm. The peak difference of the most aggressive used compensation by the reference signal is below 3 rpm, meaning less than 0.2% in speed difference is introduced as disturbance. This disturbance will only slightly impact motors above 300 kW, while for lower power ratings the disturbance will not be noticeable.

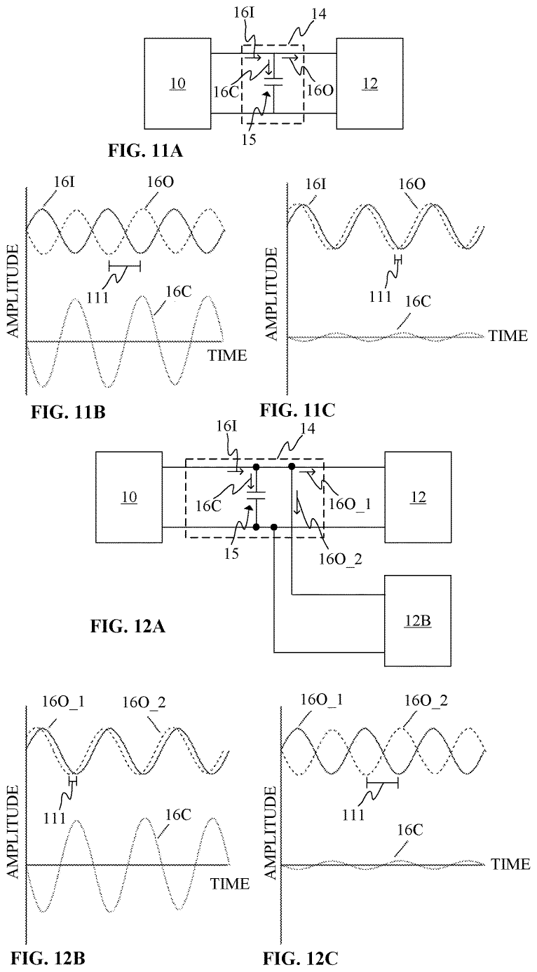

FIG. 11A-11C illustrate an example of the effect of angle difference 111 on DC link current 16C of a power converter system 100 with one input converter 10 and one output converter 12. FIG. 11A illustrates schematically the power converter system 100. As can be understood, there could be an electric source 30 connected to input of the power converter system 100 and a load 40 to output of the power converter system 100. FIG. 11A shows input current 16I of the DC link 14, output current 16O of the DC link 14, and the capacitor current 16C of the DC link 14.

As can be seen in FIGS. 11B and 11C, a larger angle difference 111 in FIG. 11B leads to a higher amplitude in the capacitor current 16C of the DC link 14 when compared to a smaller angle difference 111 in FIG. 11C and the capacitor current 16C thereof. The angle difference 111 in FIG. 11B is 180 degrees whereas in FIG. 11C it is about 40 degrees. Thus, the controller 20 of the power converter system 100 (or in the method as disclosed hereinabove) may be configured to change the angle difference 111 or perform a phase-shift in case of operating at or close to 180 degrees in order to reduce losses in the DC link 14.

FIG. 12A-12C illustrate an example of the effect of phase shift in angles of output converters 12, 12B on DC link current of a power converter system 100 with one input converter 10 and two output converters 12, 12B. As can be understood, there could be an electric source 30 connected to input of the power converter system 100 and loads 40 to outputs of the power converter system 100. The power converter system 100 may comprise a plurality of output converters 12; 12B, that is more than one, connected to the DC link 14, preferably in parallel relative to each other. There could be more than two output converters 12, 12B. Optionally, there could be two or more than two input converters 10, 10B, connected to the DC link 14, preferably in parallel relative to each other as shown in FIG. 1.

FIG. 12A shows input current 16I of the DC link 14, the first output current 16O_1 of the DC link 14 towards the output converter 12, such as the first output converter, the second output current 16O_2 of the DC link 14 towards the second output converter 12B, and the capacitor current 16C of the DC link 14. Optionally, each output power converter 12, 12B may have a local DC link capacitor with a relatively small capacitance value (not shown).

As can be seen in FIGS. 12B and 12C, a smaller phase shift between the angles of the output converters 12, 12B in FIG. 12B leads to a higher amplitude in the capacitor current 16C of the DC link 14 when compared to a smaller phase shift in FIG. 12C and the capacitor current 16C thereof. The phase shift in FIG. 12B is about 40 degrees whereas in FIG. 12C it is 180 degrees. Thus, the controller 20 of the power converter system 100 may be configured to change or perform a phase-shift to the angle for changing the angle of at least one of the output converters 12, 12B away from similar angle relative to an angle of another output converter 12, 12B in order to reduce losses in the DC link 14.

Thus, in various embodiments, the controller 20 may be configured to adjust output angles of the plurality of output converters 12, 12B relative to each other to reduce losses in the DC link 14.

In the case of FIGS. 12A-12C, the angle of the output currents 16O_1, 16O_2 can be phase-shifted if possible (e.g. 180 degrees for the two output converters 12, 12B relative to each other) such that drawing peak current (or power) from the DC link 14 simultaneously is avoided.

In addition, the controller 20 may be configured to adjust output angles of the plurality of output converters 12, 12B relative to the input angle of the power converter system 100 so that drawing peak current (or power) from the DC link 14 when the input current 16I is low (or exhibits a valley) is avoided.

Preferably, the two output converters 12, 12B may be configured to be allowed to draw power simultaneously when the input current 16I is at its peak, meaning that the DC link 15, such as capacitor or capacitors thereof, is/are charging. By doing this, the DC link ripple and power losses are decreased while the lifetime of the DC link capacitors 15 is increased.

Each output power converter 12, 12B may be configured to control its own phase shift or angle of their current according to voltage ripple in the DC link 14 such that they draw current/power e.g. around the top of the voltage ripple.

Alternatively, the output converters 12, 12B may be controlled to be operated by use of unique IDs (e.g. inverter 3 out of N) in the system 100 and perform the phase shift (if necessary) according to that (e.g. (3−1)*360 deg/n).

In some embodiments, the controlling may be based on a communication where a central controller (such as the controller 20) would set the ideal phase shift for each converter 12, 12B based on parameters, such as the number of units working, power size and unit loading.

While the present disclosure has been illustrated and described and with respect to a particular embodiment thereof, it should be appreciated by those of ordinary skill in the art that various modifications to this disclosure may be made without departing from the spirit and scope of the present disclosure.

What is claimed is:

1. A power converter system comprising:
one or more input converters with an input converter topology;
one or more output converters with an output converter topology;
a DC link comprising one or more energy storages, wherein the DC link is connected between the one or more input converters and the one or more output converters; and
a controller configured to control the one or more output converters to produce one or more output waveforms with an output frequency and an output angle, and to determine an input frequency and an input angle of the one or more input converters,
wherein the controller is configured to adjust an operating point, defined by the output frequency and the output angle, to minimize operation at one or more predefined undesirable operating point ranges for reducing losses in the DC link, wherein the one or more predefined undesirable operating point ranges are determined based on:
the input converter topology,
the output converter topology,
an angle difference between the output angle and the input angle, and
a frequency difference between the output frequency and the input frequency.

2. The power converter system of claim 1, wherein the one or more predefined undesirable operating point ranges are defined by a combination of one or more values of the output frequency and one or more values of the output angle with respect to the input frequency and the input angle.

3. The power converter system of claim 1, configured to have a nominal operating range defined by a combination of one or more values of the output frequency and one or more values of the output angle,
the nominal operating range comprising, in a non-overlapping manner, one or more acceptable operating point ranges and the one or more predefined undesirable operating point ranges,
wherein operation in the one or more predefined undesirable operating point ranges causes higher losses in the DC link than operation in the acceptable operating point ranges.

4. The power converter system of claim 1, wherein the nominal operating range further comprises one or more preferred operating point ranges.

5. The power converter system of claim 1, wherein the nominal operating range is further defined by a relative loading of the power converter system

6. The power converter system of claim 1, wherein the controller is configured to synchronize the output frequency and the output angle with the input frequency and the input angle, respectively, and
the output angle is subsequently adjusted to have a predefined angle shift relative to the input angle for avoiding operating at one or more undesirable phase angles related to the one or more predefined undesirable operating point ranges.

7. The power converter system of claim 1, wherein the controller is configured to adjust the output angle to change pass one or more undesirable phase angles related to the one or more predefined undesirable operating point ranges faster than in case of operating points around the one or more predefined undesirable operating point ranges.

8. The power converter system of claim 7, wherein the adjusting of the output angle is based on a control reference providing a higher rate of angle change at the one or more undesirable phase angles than at phase angles around the one or more undesirable phase angles.

9. The power converter system of claim 8, wherein the control reference is a chirp like signal arranged to produce the higher rate of angle change at the one or more undesirable phase angles.

10. The power converter system of claim 1, wherein the controller is configured to adjust the output frequency to be different than the input frequency by a predefined frequency shift for ensuring faster transition pass one or more undesirable phase angles related to the one or more predefined undesirable operating point ranges.

11. The power converter system of claim 1, comprising a plurality of output converters connected to the DC link, wherein the controller is configured to adjust output angles of the plurality of output converters relative each other to reduce losses in the DC link.

12. The power converter system of claim 11, wherein the controller is configured to adjust output angles of the plurality of output converters relative to the input angle of the power converter system to reduce losses in the DC link.

13. A method for operating a power converter system for reducing losses in a DC link of the power converter system, the power converter system comprising one or more input converters with an input converter topology and one or more output converters with an output converter topology, wherein the DC link comprises one or more energy storages and is connected between the one or more input converters and the one or more output converters, the method comprising:
determining an input frequency and an input angle of the power converter system, and
adjusting an output frequency and an output angle of the one or more output converters to minimize operation at one or more pre-defined undesirable operating point ranges for reducing losses in the DC link, wherein the one or more predefined undesirable operating point ranges are determined based on: the input converter topology, the output converter topology, an angle difference between the output angle and the input angle, and a frequency difference between the output frequency and the input frequency.

14. The method of claim 13, comprising
synchronizing the output frequency and the output angle with the input frequency and the input angle, respectively, and
subsequently adjusting the output angle to have a predefined angle shift relative to the input angle for avoiding operating at one or more undesirable phase angles related to the one or more predefined undesirable operating point ranges.

15. The method of claim 13, comprising adjusting the output angle to change pass one or more undesirable phase angles related to the one or more predefined undesirable operating point ranges faster than in case of operating points around the one or more predefined undesirable operating point ranges.

16. The method of claim 15, wherein the adjusting of the output angle is based on a control reference providing a higher rate of angle change at the one or more undesirable phase angles than at phase angles around the one or more undesirable phase angles.

17. The method of claim 16, wherein the control reference is a chirp like signal arranged to produce the higher rate of angle change at the one or more undesirable phase angles.

18. The method of claim 13, comprising adjusting the output frequency to be different than the input frequency by a predefined frequency shift for ensuring faster transition pass one or more undesirable phase angles related to the one or more predefined undesirable operating point ranges.

19. The method of claim 13, wherein the power converter system comprises a plurality of output converters connected to the DC link, the method comprising adjusting output angles of the plurality of output converters relative each other and, optionally, relative to the input angle of the power converter system to reduce losses in the DC link.
